(19) United States
(12) Patent Application Publication
(10) Pub. No.: US 2020/0353847 A1
(43) Pub. Date: Nov. 12, 2020

(54) Vehicle Seat with Integrated Safety Seat Connection

(71) Applicant: Pidyon Controls Inc., New York, NY (US)

(72) Inventors: Yochanan Cohen, New York, NY (US); Jonathan I. Gordon, New Haven, CT (US)

(73) Assignee: Pidyon Controls Inc., New York, NY (US)

(21) Appl. No.: 16/960,377

(22) PCT Filed: Dec. 17, 2018
(86) PCT No.: PCT/US2018/066085

§ 371 Date: Jul. 7, 2020

Related U.S. Application Data
(60) Provisional application No. 62/607,005, filed on Dec. 18, 2017.

(51) Int. Cl. B60N 2/28; B60N 2/68

(52) U.S. Cl. CPC B60N 2/28; B60N 2/682

(57) ABSTRACT

A vehicle seat includes a vehicle seat frame connected directly to a chassis/frame of a vehicle. The seat frame includes a back portion and a seat bottom portion. The seat bottom portion includes at least one connector configured for removably connecting to at least one corresponding connector of a car seat. The vehicle seat also includes a cover configured to connect to the frame and cover the frame and conceal the connector of the seat bottom portion. At least one portion of the cover is partially or wholly removable to expose the connector of the seat bottom portion so that connector of the seat bottom portion can be used to connect to the corresponding connector of the car seat. In one embodiment, a portion of the cover covering the back portion may be removable to increase spacing around the car seat.

### BACKGROUND

### 1. Field

The present disclosure relates to vehicle seats connected to a chassis or frame of a vehicle. More particularly, the present disclosure relates to vehicle seats with connections for safety car seats. The safety car seats may be for infants or toddlers, although they are not limited thereto.

### 2. State of the Art

The most common cause of death for children aged 1-5 in developed countries is by accident, and the leading cause of death by accident is car accidents. When properly installed in passenger cars, child safety seats have been reported to reduce fatal injury by about 71% for children (i.e., infants) under age one and by about 54% for toddlers aged 1-4. Nonetheless, in the U.S. alone, over 250 children aged 0-4 are fatally injured every year while properly restrained in their car seats.

In addition, to the fatalities, every year, thousands of children who are properly restrained in car seats still sustain incapacitating injuries resulting from car accidents. By far the most common severe injuries are head injuries, including cerebrum injuries (contusions or lacerations), concussions, skull vault and skull base fractures, subarachnoid hemorrhages, and subdural hematomas. Other common severe injuries are thoracic (lung and rib), abdominal (bowel, liver, spleen, kidney), spine, and upper extremity (clavicle, humerus, radius/ulna) and lower extremity (pelvis, femur, tibia/fibula) injuries. The injury outcome in children can be worse than similar injuries sustained by adults, and children who suffer traumatic brain injuries can experience lasting or late-appearing neuropsychological problems. For example, frontal lobe functions develop relatively late in a child's growth, so that injury to the frontal lobes may not become apparent until the child reaches adolescence.

According to the U.S. National Highway Traffic and Safety Administration (NHTSA), children under the age of one should always ride in a rear-facing car seat that has a harness. While it is recommended that rear-facing seats be used as long as possible, it is recognized that children aged 1 and over will wish to face forward. NHTSA recommends that children aged 1-3 (and older if they have not reached a certain height and weight) use a forward-facing car seat with a harness and tether that limits the child's forward movement during a crash.

There are many types of car seats available for purchase. Infant seats recommended for children under age 1 are rear-facing. Many include a base that is belted or tethered into the car and a seat that can latch into the base. The seat often includes a handle so that the seat may be carried when it is unlatched from the base (i.e., from the car). A popular car seat option for infants as well as children is a “convertible” car seat that may be oriented in a rear-facing position and then “converted” to a front-facing position. Some convertible car seats may even convert into a booster seat for children weighing up to 100 pounds. Typically the convertible car seats are strapped into the car using the car seat-belt, or are anchored to the car frame directly using a LATCH (Lower anchors and Tethers for children) system. All car seats offer a harness for strapping the child into the seat. The usual harness is a five-point safety harness. The car seats tend to be formed from injection molded plastic, typically at least 5 mm (0.2 in) thick, and the seats (with base in the case of the infant seats) typically weigh 7 kgs (15.4 lbs) or more.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

According to one aspect of the disclosure, a vehicle seat includes a vehicle seat frame configured to connect directly to a chassis of a vehicle. The seat frame includes a back portion and a seat bottom portion extending at an angle with respect to the back portion. The seat bottom portion includes connectors that are configured for removably connecting to corresponding connection points of a car seat, such as an infant safety seat. The seat also includes a cover that is configured to connect to the frame. The cover includes at least one portion, which, in a first configuration, covers and conceals the connectors, and in a second configuration, exposes the connectors. At least one portion of the cover is partially or wholly removable to expose the connectors of the frame so that they can be used to connect to a car seat.

In one embodiment, the portion of the cover that conceals the connectors is separable from the cover. In at least one other embodiment, the portion of the cover that conceals the connectors is partially connected to the cover and is configured to fold over onto the cover to expose a corresponding connector.

According to one embodiment, the vehicle seat includes a cushion material, such as foam, disposed between an outer surface of the cover and the seat frame.

According to aspects of the vehicle seat, the vehicle frame may include a car seat base, which can be concealed in a first configuration when not in use, and exposed in a second configuration when needed to connect a car seat, such as an infant child car seat. Owing to this feature, a user need not install a separate car seat base on top of the vehicle seat cushions or remove and store such a base when no longer needed. Therefore, use of a car seat can be greatly simplified and installation can be improved.

### BRIEF DESCRIPTION OF THE DRAWINGS

FIG. 1A is a view of a car seat mounting frame described in co-owned U.S. Patent Application Publication No. 2016/03322542 (Cohen et al.).

FIG. 1B shows a car seat described in co-owned U.S. Patent Application Publication No. 2016/0332542 (Cohen et al.).

FIG. 1C shows a bottom view of the car seat shown in FIG. 1B.

FIG. 1D shows the car seat shown in FIG. 1B connected to the car seat mounting frame shown in FIG. 1A.

FIG. 2 shows an embodiment of a car seat mounting frame incorporated into a vehicle seat in accordance with an aspect of the disclosure.

FIG. 3A shows a horizontal portion of another embodiment of a car seat mounting frame in accordance with an aspect of the disclosure.

FIG. 3B shows a modified version of the car seat shown in FIG. 1B.

FIG. 3C shows a bottom view of the car seat of FIG. 3B.

FIG. 4 shows a top plan view of the car seat mounting frame of FIG. 3A, with only the female sockets of the frame shown for clarify of illustration.

FIG. 5 shows a schematic side section view of a latching female socket of the frame shown in FIG. 3A along with a corresponding male projection.

FIG. 6 shows a plan view of an embodiment of a seat panel including removable plugs in accordance with an aspect of the disclosure.

FIG. 7 shows a plan view of an embodiment of a seat panel including a shutter (shown in alignment with holes in a mounting frame) in accordance with an aspect of the disclosure.

FIG. 8A shows a side view of another embodiment of a vehicle seat frame that includes folding car seat mounting arms.

FIG. 8B shows an enlarged view of a car seat mounting arm shown in FIG. 8A.

FIG. 8C shows a plan view of the vehicle seat frame of FIG. 8A.

FIG. 8D shows an enlarged view of a latch shown in FIG. 8C.

### DETAILED DESCRIPTION

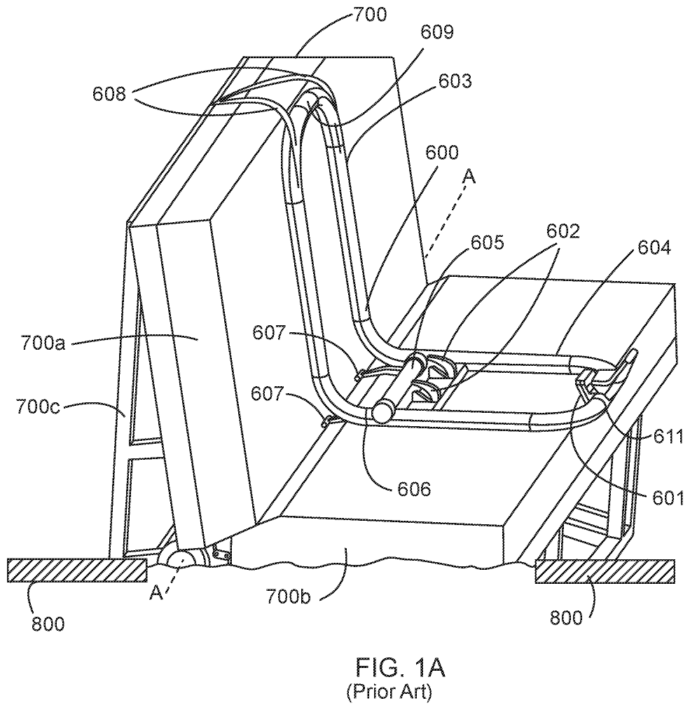

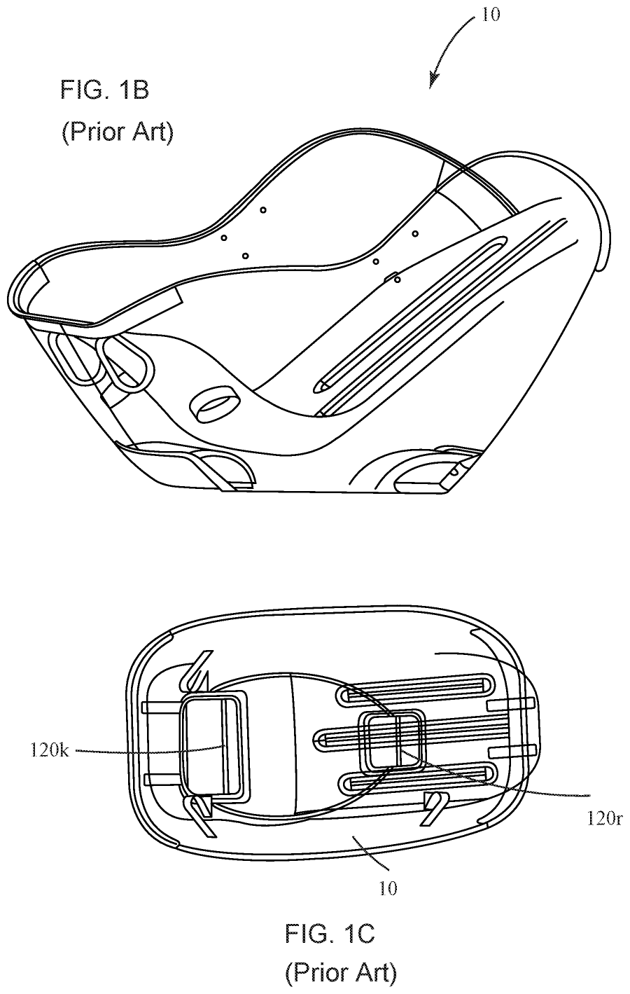

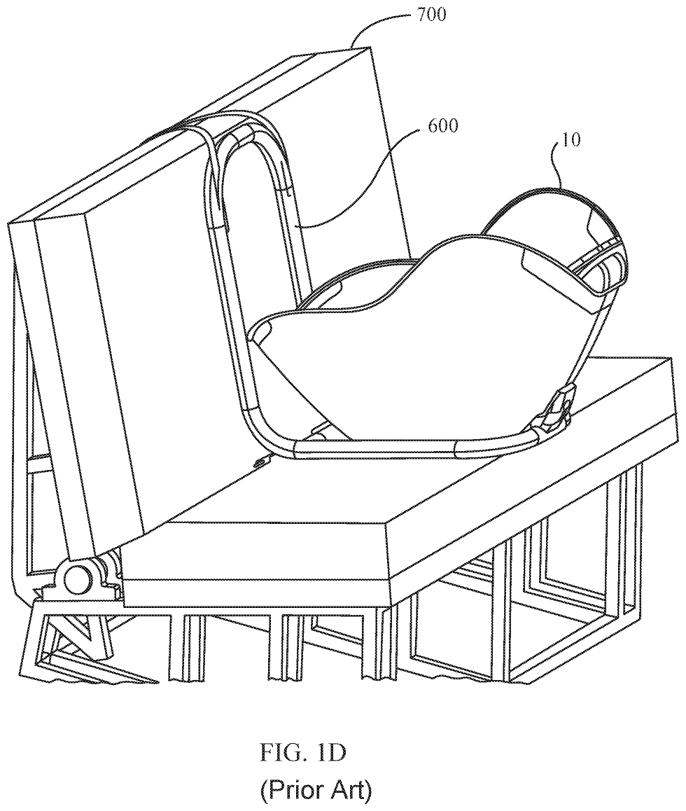

FIGS. 1A and 1D show a frame 600 that can be used in conjunction with a car seat 10 (FIGS. 1B, 1C. 1D), which is described in co-owned U.S. Patent Application Publication No. 2016/0332542, the entire contents of which are incorporated herein by reference. The frame 600 sits on top of and is connected to a vehicle seat 700. As shown most clearly in FIG. 1A, the frame 600, includes a substantially vertical (within about 25 degrees of vertical) portion 603 and a substantially horizontal (within about 25 degrees of horizontal) portion 604, which extend from one another at an angle. In one embodiment, the angle is approximately 97 degrees (it being noted that the term “approximately” as used herein in the specification and claims with respect to angles includes plus or minus 3 degrees). In the embodiment shown in FIG. 1A the vertical portion 603 and the horizontal portion 604 are both generally u-shaped members having the same width. The frame 600 has connectors 607 for connecting to anchor locations built into the seat 700. Also, the frame 600 has top tether connections 608, which extend above an upper end 609 of the vertical portion 603, and that secure the vertical portion 603 to another anchor location of the frame 700. Further details of the connection of the frame 600 to the car seat 10 is described in co-owned U.S. Patent Application Publication No. 2016/0332542.

The frame 600 may be formed of metal, such as aluminum. Of course, in other embodiments, the frame may be formed of other metals, such as titanium and steel, or non-metals, such as carbon fiber and plastic. Also, the horizontal and vertical portions 604 and 603 may be hollow or may be solid. For example, in one embodiment, the horizontal and vertical portions 604 and 603 are formed of tubular aluminum having a wall thickness of about 2 mm and an outer diameter of about 31.75 mm. It should be appreciated that for purposes herein, the term “tubular” does not require that a cross-section be round, as the tubular element may take any of many shapes.

The horizontal portion 604 extends from a front 611 to a back (mar) 606. The horizontal portion 604 has a cross bar 605 at or near the rear 606 of the horizontal portion 604. A pair of connectors 607, such as mini-connectors, extends from the cross bar 605. The connectors 607 are free to rotate relative to the cross bar 605. The connectors 607 are constructed to removably couple to anchors 700c (e.g., LATCH anchors) of the vehicle seat 700, which are located in the bight of the seat 700. In one embodiment, the vertical and horizontal portions 603 and 604, and cross bar 605 are formed of a metal, such as aluminum, and may be solid or tubular in form. The width between the connectors 607 is about the same as the width of the horizontal portion 604. In one embodiment, for example, the width between the connectors 607 may be about the standard width of vehicle anchors (e.g., LATCH anchors) of the vehicle seat, which is about 11 inches. Such dimensions are merely exemplary and are not intended to be limiting.

The horizontal portion 604 has a pair of hooks 602 and a latch mechanism 601, which is at or near the front of the horizontal portion 604. The hooks 602 are configured to hook to a corresponding first rod 120k (FIG. 1C) on a bottom side of the car seat 10. The latch mechanism 601 is configured to selectively lock and unlock from a corresponding second rod 120r (FIG. 1C) on the bottom side of the car seat 10. The latch mechanism 601 has a handle which a user can selectively operate to unlock the latch mechanism 601 to disconnect the car seat 10 from the frame 600.

The vehicle seat 700 includes a seatback portion 700a, a seat bottom portion 700b, and a seat frame 700c to which the seatback portion and seat bottom portion are secured. The seat frame 700c includes structural members that connect directly to the chassis or frame 800 of the vehicle. The frame 700c provides rigid support for the seatback portion 700a and seat bottom portion 700b, which may include padded upholstery and fabric, leather, or vinyl coverings. The seatback portion 700a may be pivotally adjustable with respect to the seat bottom portion 700b about axis A-A to permit the seat back portion 700a to recline back and forth and/or fold flat onto the seat bottom portion 700b.

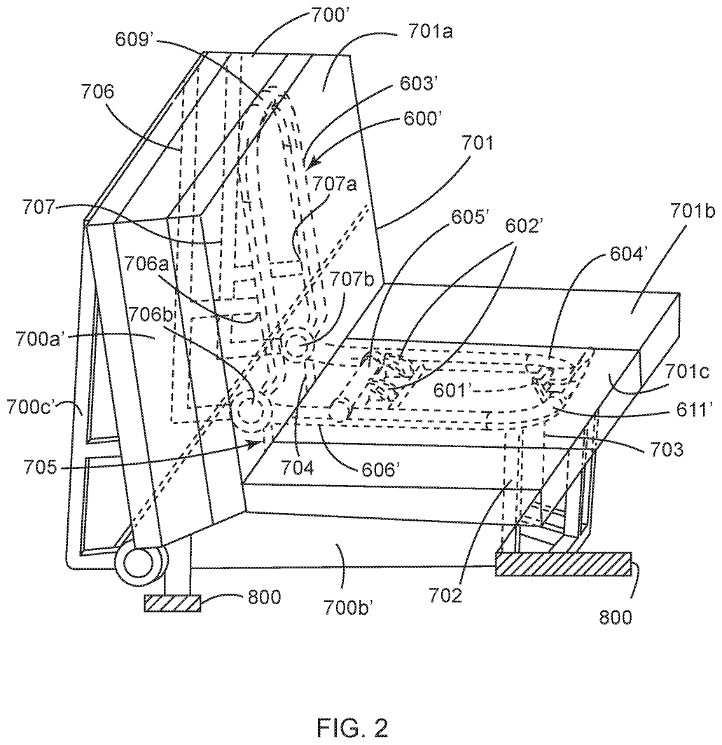

FIG. 2 illustrates a vehicle seat 700′ in which another frame 600′ is incorporated permanently into a modified vehicle seat frame 700c′ and is covered by a seat upholstery cover 701 so that an occupant of the vehicle can sit on the cover 701 when the seat 700′ is not connected to a car seat, such as car seat 10. Like reference numbers in FIG. 2 to those in FIG. 1 are appended with an apostrophe (′). In one embodiment, the frame 600′ or portions (e.g., the pair of hooks 602′ and the latch mechanism 601′) thereof, may be permanently attached, such as by welding or other secure fastening, to the vehicle seat 700′ so that the frame 600′ or the portions thereof that are so attached are not readily separable from the vehicle seat 700′ but become integral with the seat 700′ so that when the seat 700′ is attached to the vehicle chassis 800 the frame 600′ or portions thereof are secured to the chassis 800 as well.

The seat upholstery cover 701 has a seat bottom portion 701b that covers the horizontal portion 604′ of the frame 600′. Also, the seat upholstery cover 701 has a seat back portion 701a that covers the vertical portion 603′ of the frame 600′. While shown in FIG. 2 as a unitary layer, the seat upholstery cover 701 may include any number of layers of upholstery including, fabric, leather, vinyl, and foam or other cushioning materials, springs and other upholstery elements known in the art.

The horizontal portion 604′ of the frame 600′ is connected to the vehicle chassis 800 via frame members 702 and 703 at the front 611′ of the horizontal portion 604′, and via frame members 704 and 705 at the rear 606′ of the horizontal portion 604′. The vertical portion 603′ of the frame 600′ is connected to frame members 706 and 707 at lower ends 706b and 707b thereof and an intermediate spaced locations 706a and 707a above the lower ends of the frame members 706 and 707. The vertical portion 603′ may also or alternatively be connected to the frame members 706 and 707 at the upper end 609′ of the vertical portion 603′. The lower ends 706b and 707b of the frame members 706 and 707 are pivotally connected to the rear 606′ of the horizontal portion 604′ of the frame 600′. This pivotal configuration permits the vertical portion 603′, the seatback portion 700a′, and the seatback portion 701a of the cover 701 to fold together relative to the horizontal portion 604′, the seat bottom portion 700b′, and the seat bottom portion 701b of the cover 701. The pivotal connection between the frame members 706, 707, and the horizontal portion 604′ may be locked into one or more relative angular positions with a suitable locking mechanism (not shown) that will retain the locked position even in the event of severe forces and torque that may be transferred to the mechanism during a vehicle accident. Thus, once the locking mechanism is locked, the horizontal portion 604′ and the vertical portion 603′ of the frame 600′ may effectively be considered structurally unitary.

The seat bottom portion 701b of the cover 701 may include a removable panel 701c that is directly above the horizontal portion 604 of the frame 600. The panel 701c is configured to be moved to expose the connections of the horizontal portion 604 of the frame so that a car seat (e.g., car seat 10) can be connected to the frame 600. The panel 701c may be partially or wholly removable from the rest of the seat bottom portion 701b. For example, the panel 701c may be permanently or removably connected along its rear edge to the seat back portion 701a so that panel can be rotated upward about its rear edge toward the seat back portion 701a to uncover the horizontal portion 604 of the frame 600′. Also, instead of folding the panel 701c out of the way, the panel may be removed completely if the connection at the rear edge of the panel 701c is readily removable, such as if it includes hook and loop fasteners or snap connectors and the like.

It will be appreciated that in at least one embodiment, the vertical portion 603′ of the frame 600′ is omitted from the frame 600′, such that only the horizontal portion 604′ is connected to the vehicle seat 700′. Thus, in this embodiment, only the horizontal portion 604′ of the frame 600′ is secured to the vehicle chassis 800 via the seat bottom portion 700b′ and frame members 702 and 703 at the front 611′ of the horizontal portion 604′, and via frame members 704 and 705 at the rear 606′ of the horizontal portion 604′. This arrangement can further simplify construction of the vehicle seat 700′. Moreover, in at least one other embodiment, in addition to omitting the vertical portion 603′ of the frame 600′, the outer u-shaped frame member of the horizontal portion 604′ may be omitted so that only the pair of hooks 602′ and the latch mechanism 601′ of horizontal portion 604′ are fixed to bottom seat portion 700b′ of the vehicle seat frame 700c′.

In one embodiment, the seat back portion 701a of the cover 701 that covers the vertical portion 603′ may be removable or have a panelized portion (e.g., a lower portion) that can be removed. For example, vehicle seatback cushions may be about three to five inches thick. Therefore, by removing the seat back portion 701a, additional space (volume) can be freed up to accommodate the car seat and its occupant. For example, the additional space freed up by removing the seat back portion 701a can increase the legroom for rear-facing car seat occupants. Also, the additional space may be used to move the locations of the hooks 602 and latch mechanism 601 rearward, which can permit a car seat to be connected to the seat 700′ at a position spaced further away from the seatbacks (not shown) of vehicle seats (not shown) immediately forward of the seat 700′. This may allow for the installation of a larger car seat in smaller vehicles that might not otherwise accommodate the larger car seat if the additional space were not available. Also, increasing the spacing between a connected car seat and the seatbacks (not shown) of vehicle seats (not shown) immediately in front of the seat 700′ may aid in reducing the likelihood of the car seat and/or its occupant from contacting those seatbacks during a collision or during fore and aft adjustment of those seatbacks. This may be more relevant in vehicles having passenger compartments with limited legroom.

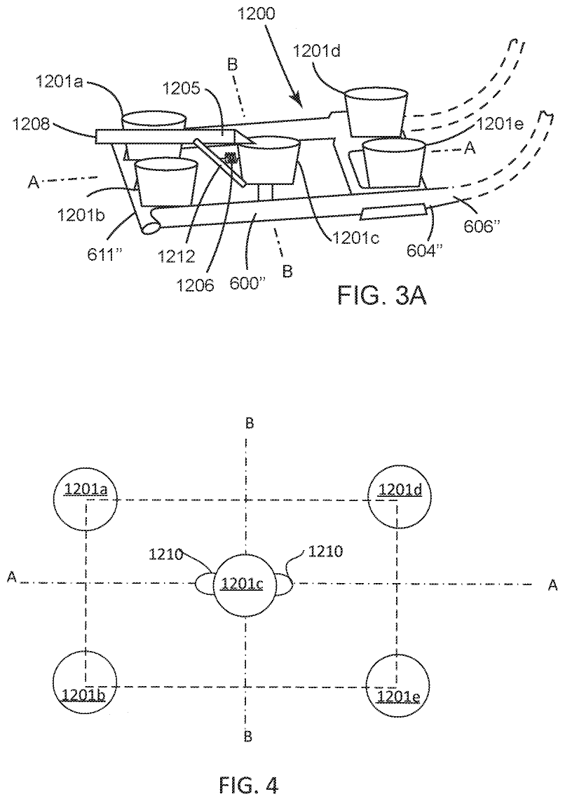

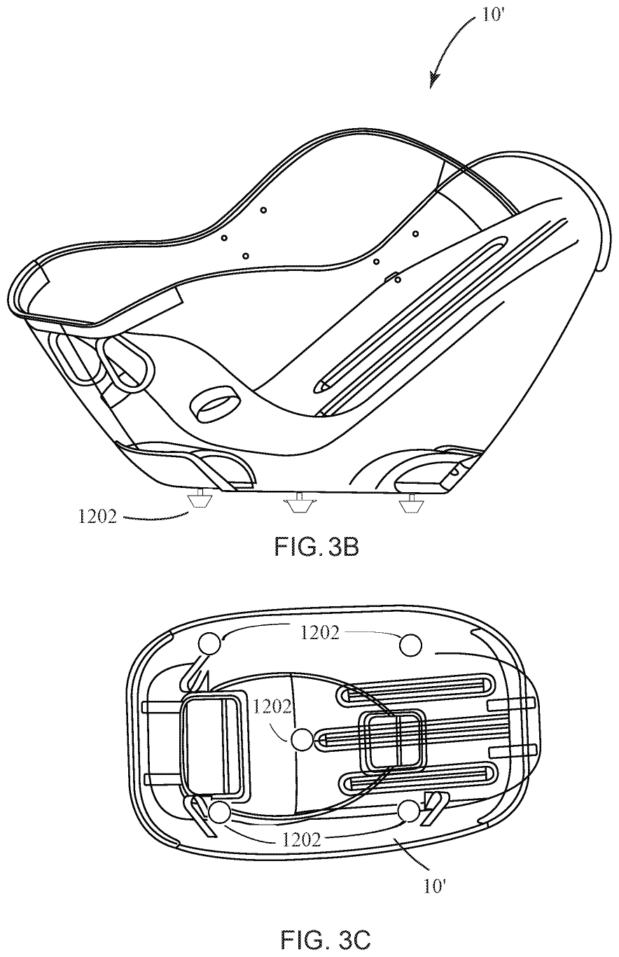

FIG. 3A shows another embodiment of a horizontal portion 604″ of a frame 600″ which can be substituted for the horizontal portion 604′ of the frame 600′ in FIG. 2. In FIG. 3A like elements to those in FIG. 2 are appended with two apostrophes (″). The frame 600″ incorporates a connection arrangement or system 1200 for connecting the frame 600″ to a car seat 10′ (FIGS. 3B and 3C), which is a modified version of the car seat 10 shown in FIGS. 1B, 1C, and 1D. The connection system 1200 permits the car seat 10′ to be connected only in two orientations: a forward facing (seat occupant facing towards the front of the vehicle and opposite the seatback) and a rear facing (seat occupant facing the seatback) orientation. Thus, a user of the car seat 10′ is restricted from connecting the car seat 10′ to the frame 600′ in any other orientation, such as sideways. Further details of the connection arrangement will now be described.

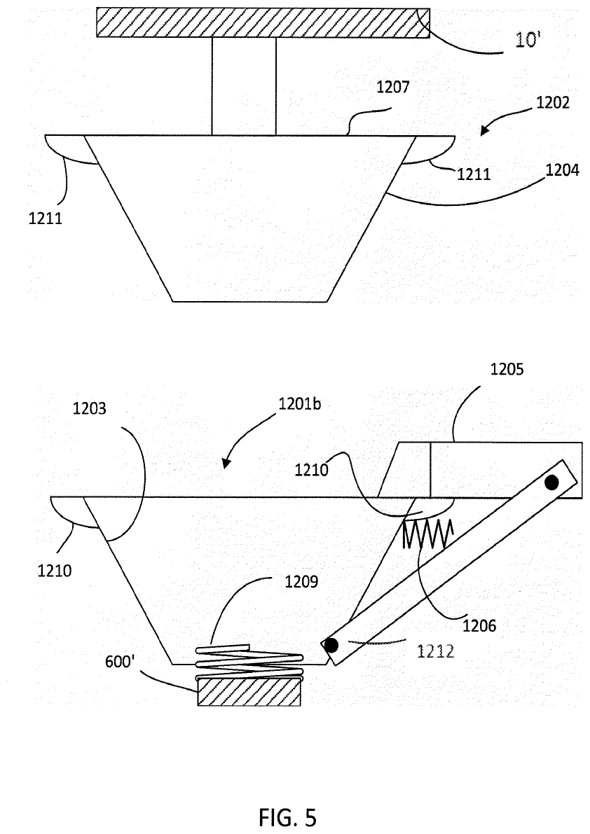

The frame 600″ has at least one female socket 1201 that is configured to receive a male projection 1202 (FIGS. 3B, 3C, and 5) extending from the bottom of the car seat 10′. As shown in FIG. 3A, five female sockets 1201a-1201e are included, with four sockets 1201a, 1201b, 1201d, and 1201e positioned at cornets of a rectangle (shown in broken lines in FIG. 4) and one socket 1201c at the center of that rectangle. The rectangle has its longer dimension along axis A-A. As shown in FIG. 3C, the male projections 1202 are arranged on the bottom of the car seat 10′ in the same pattern of the sockets 1201 shown in FIG. 4 with the longer dimension of the rectangle aligned front to back of the bottom side of the car seat 10′. Accordingly, the male projections 1202 can only align with the female sockets 1201 when the car seat 10′ is facing forward or rearward along axis A-A with respect to the frame 600′. It will be appreciated that in one embodiment, the car seat 10′ may have three male projections 1202 instead of five since the rectangular pattern of the sockets 1201 is symmetrical about axis B-B, which is transverse to axis A-A and passes centrally through the socket 1201c located in the center of the pattern shown in FIGS. 3A and 4. Thus, in one embodiment of the car seat, the three male projections 1202 align with sockets 1201c, 1201d, and 1201e when facing forward, and align with sockets 1201a. 1201b, and 1201c when facing rearward. While a rectangular pattern or arrangement of sockets is described above for one example embodiment, it will be appreciate that in other embodiments the sockets may be arranged in other patterns, such as a diamond pattern.

Moreover, in one embodiment, only a single socket 1201 may be provided with a keyed feature to ensure alignment of the seat 10 with the frame 600″ in one corresponding direction. For example, as shown in FIG. 4, the central socket 1201 may incorporate one or both of keyed features 1210, shown as rounded tabs. Such tabs 1210 may be rounded, squared, triangular, or irregular in shape. The tabs 1210 are configured to align with and mate to corresponding features 1211 (FIG. 5) on the bottom of the car seat 10′ so that the car seat 10′ can only be connected to the frame 600″ when the tabs 1210 and mating features of the car seat bottom align with one another.

FIG. 5 illustrates details of one embodiment of a central socket 1201c and a corresponding male projection 1202. Female socket 1201c has an inner surface 1203 that corresponds to the outer surface 1204 of the male projection 1202, so that the female socket 1201c and male projection 1202 operatively align. In the example shown in FIG. 5, the inner surface 1203 and the outer surface 1204 are frustoconical or otherwise tapered. A latch 1205 is coupled to socket 1201c to selectively lock a corresponding male projection 1202 in socket 1201c to retain the car seat 10 in a connected configuration to the frame 600″. For example, as shown in FIGS. 3A and 5, the latch 1205 is pivotally connected to the socket 1201c with a linkage 1212 and is biased with a spring 1206 so that the latch 1205 is biased to move leftward into a closed position that is shown in FIG. 5. The male projection 1202 has an annular flange 1207 at an upper end of the frustoconical surface 1204. The latch 1205 is configured to slide along annular flange 1207. Sockets 1201a, 1201b, 1201d, and 1201e may have the same construction as socket 1201c, but may optionally omit having the latch 1205, as in the embodiment shown in FIG. 3A.

Prior to a connection process of connecting seat 10′ to the frame 600″, a user would uncover the sockets 1201a to 1201e by partially or fully removing the panel 701c′. During a connection process of the car seat 10′ to the frame 600″, a user places the car seat 10′ over the frame 600″ with the male projections 1202 extending downwardly facing the sockets 1201 and places the seat 10′ on the frame 600″ preferably in the vicinity of the sockets 1201. If the male projections 1202 do not initially align with the sockets 1201, the user can slide the car seat 10′ front to back and/or left to right relative to the frame 600″ until the projections 1202 align with the female sockets 1201. When the projections 1202 and the female sockets 1201 are aligned, the user can push the seat 10′ further downward into the frame to move the latch 1205 to the side of the opening of the socket 1201 and into an open position to clear the annular flange 1207 of the male projection 1202. Once the male projection 1202 is fully seated in the female socket 1201c, the latch 1205 automatically moves to the side over the upper flange 1207 of the male projection 1202, thereby locking the projection 1202 in the socket 1201c. The female socket 1201c can be unlocked from the male projection 1202 by displacing the latch 1205 to clear of the annular flange 1207 of the projection 1202, such as using a handle 1208 (FIG. 3A) and pulling the seat 10′ upward. Also, optionally, a spring 1209 may be positioned in the bottom of the sockets 1201 to urge the seat 10 away from the frame to facilitate separating the seat 10′ from the frame by having the seat automatically lift slightly upwards once the latch 1205 is displaced from the locking position to the open position.

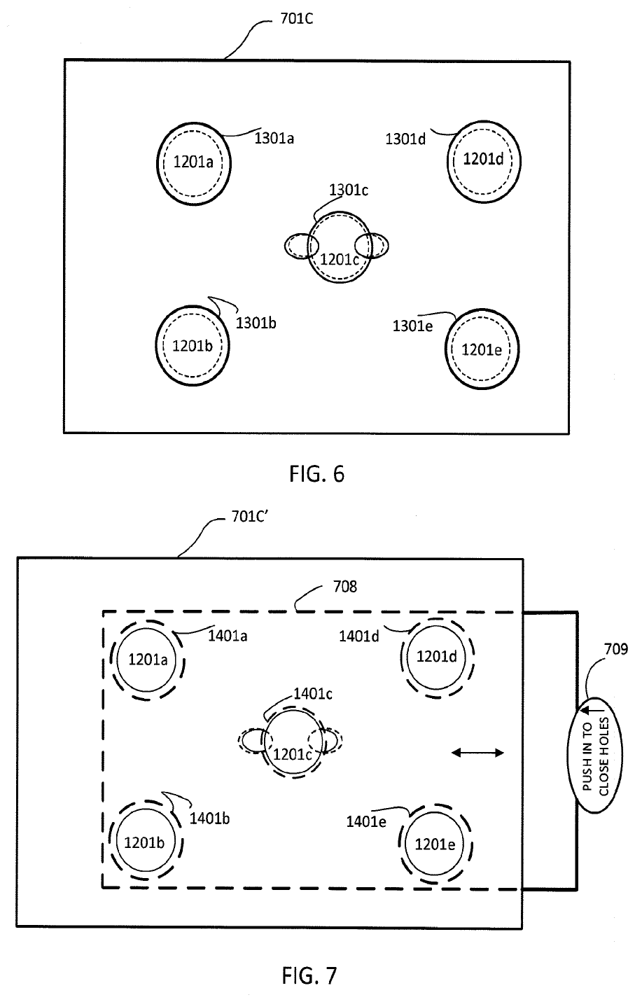

In an embodiment in which the frame 600″ is incorporated into the frame 700c′ the panel 701c may be alternately configured to have plug portions 1301a-1301e, as shown in FIG. 6, above and aligned with each of the sockets 1201a-1201e. The plug portions 1301a-1301 are configured to be partially or wholly removed from the panel 701c to uncover the sockets 1201a-1201e. A user can remove the plugs 1301a-1301e before connecting the seat 10′ to the sockets 1201a-1201e and the user can replace the plugs into the panel 701c to cover the sockets 1201a-1201e when the car seat 10′ is not connected.

In an alternate embodiment, not shown, the plugs 1301a-1301e are not removable from the seat panel 701c, but instead are compressible and may be pushed down into the sockets 1201a-1201e by pushing on the plugs with the projections 1202. A user wishing to connect the car seat 10′ to the vehicle seat 700′ can align the projections 1202 of the seat with the locations of the plugs 1301a-1301e and push the seat 10′ down to compress the plugs into the sockets 1201a-1201e, which may be configured with sufficient depth to receive and accommodate the compressed plugs when the projections 1202 are fully connected in the sockets 1201a-1201e. Also, the plugs 1301a-1301e may be spring biased in the sockets 1201a-1201e to automatically rise upward to their original uncompressed level when the car seat 10 is disconnected from the vehicle seat 700′. Preferably, in the uncompressed level, the plugs 1301a-130e are flush with the surface of the panel 701c.

Also, in one embodiment shown in FIG. 7, the sockets 1201a-1201e may be concealed by a retractable shutter 708, which can be integrated into the panel 701c′. The shutter 708 is shown as a plate defining a plurality of holes 1401a-1401e that are configured to align with sockets 1201a-1201e when the shutter 708 is in an extended position relative to the panel 701c′ and to not align with sockets 1201a-1201e when the shutter 708 is in a retracted position relative to the panel 701c′. When the shutter 708 is in the extended position shown in FIG. 7 and the holes 1401a-1401e are aligned with sockets 1201a-1201e, the projections 1202 (FIG. 5) can be received in the sockets to connect the car seat 10′ to the frame 600″ which is integrated into the vehicle seat frame 700c′, as described above. The shutter 708 can be moved between its retracted and extended configurations by a user pulling or pushing on the finger tab 709. The shutter 708 may be biased to move back to the retracted position from the extended position upon disconnection of the car seat 10 from the frame 600″. The shutter 708 can be formed as a plate-like member and be made from sturdy materials such as rigid plastic or metal, and be incorporated into a sliding channel below an upper layer of seat upholstery material (e.g., fabric, leather, vinyl) and preferably as close to the upper layer as possible to minimize discontinuities in surface of the panel 701c′.

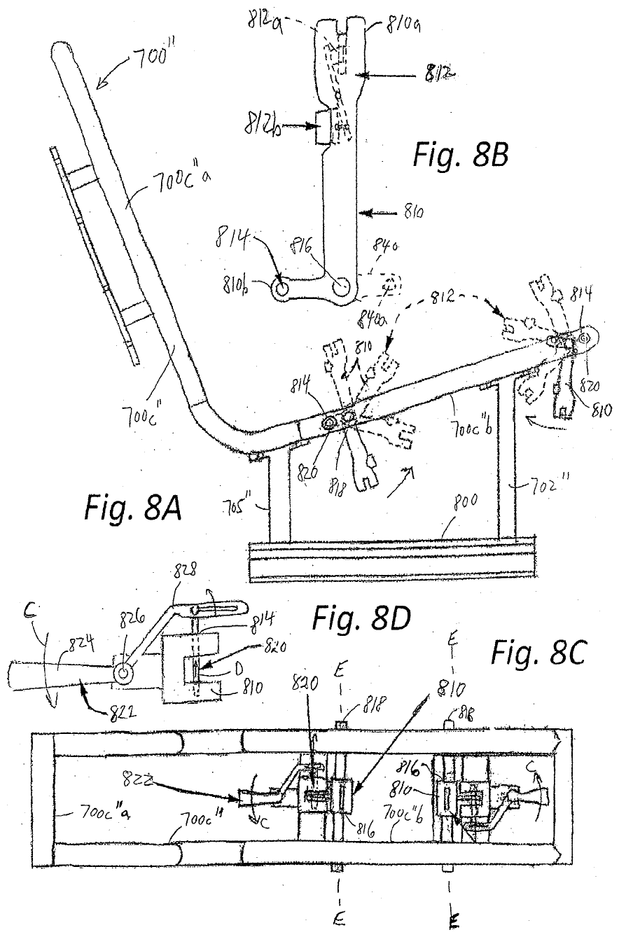

FIGS. 8A-8D show yet another embodiment of a vehicle seat frame 700c″ having car seat mounting arms 810. Like reference numbers in FIGS. 8A-8D to those in FIG. 2 are appended with a double apostrophe (″). The vehicle seat frame 700c″ has a bottom portion 700c″b and a back portion 700c″a. The bottom portion 700c″b is fixed to the vehicle chassis 800 by legs 702″ and 705″. Car seat mounting arms 810 are pivotally connected to the bottom portion 700c″b of the frame 700c″, as shown in greater detail in FIGS. 8A and 8C. In the embodiment shown in FIGS. 8A-8D, two car seat mounting arms 810 are shown, though, one or more than two arms 810 may be used in other embodiments.

The car seat mounting arms 810 are configured to pivot between a deployed configuration and a retracted configuration. In the deployed configuration, the arms extend above the bottom portion 700c″b and in the retracted configuration, the arms extend flush with or below the bottom portion 700c″b. In one embodiment, in the deployed configuration, the mounting arms 810 extend at an angle of about 90 degrees with respect to a plane of the bottom portion 700c″b. The mounting arms 810 are configured to be locked in the deployed configuration by a latch 822 (FIGS. 8C and 8D), further details of which are described below. In one embodiment, the mounting arms 810 are configured to also be locked in the retracted configuration by the latch 822. When in the deployed configuration, a car seat, such as car seat 10 (FIGS. 1B, 1C, and 1D), can be removably connected to a connector 812 on each arm 810. When not needed for connecting to a car seat, the mounting arms 810 can be folded into their retracted configuration and locked.

FIG. 8B shows the details of one of the mounting arms 810. The mounting arm 810 has a car seat connector 812 atone end 810a and a locking hole 814 defined at another end 810b. The car seat connector 812 includes an inner latch 812a for connecting to a mating connector of a car seat, such as car seat 10. Also, the car seat connector 812 includes a release button 812b for opening the latch 812a to permit a connected car seat to be removed from the connector 812. It will be appreciated that one or both arms 820 may be modified with different connectors 812, depending on the mating connector(s) of the car seat that will be connected to the connectors 812. For example, one or both of the connectors 812 may omit the latch 812a and release button 812b to connect to a car seat that instead includes a latch and release button.

As shown in FIG. 8B, the mounting arm 810 may have an “L” shaped profile. The arm 810 defines a hole 816 at a corner located between the ends 810a and 810b. The hole 816 is configured to receive a pivot pin 818 (FIGS. 8A and 8C). The pivot pin 818 extends through the pivot point 816 and through (e.g., horizontally) bottom portion 700c″b, as shown more clearly in the plan view in FIG. 8C. Each mounting arm 810 is configured to rotate about an axis E-E (FIG. 8C) along a length of the pivot pin 818. The locking hole 814 is configured to receive a locking pin 820 (FIGS. 8A, 8C, and 8D) in the deployed position. For example, as shown in FIGS. 8A, 8C, and 8D, when the arm 810 is in a fully deployed configuration, the locking pin 820 extends through the hole 814 to lock the arm 810 in the deployed configuration. In one embodiment, to permit the arm 810 to lock in both the deployed and retracted configurations, the arm 810 may optionally include a flange 840 (shown in broken lines in FIG. 8B) that defines a locking hole 840a, such that the arm 810 has a “T”-shaped profile. As discussed in greater detail below, the hole 840a is configured to receive the locking pin 820 when the arm 810 is in the retracted configuration.

As shown in FIG. 8C, connected to the bottom portion 700c″b are latches 822 that are used by a user to selectively move the locking pin 820 in and out of locking engagement with the hole 814 (and hole 840a, if present). As shown in greater detail in FIG. 8D, each latch 822 has a handle 824 rigidly connected to an arm 828 with the handle 824 and arm 828 both pivoting about pin 826. When the handle 824 is rotated in the direction of arrow C in FIGS. 8C and 8D, the arm 828 rotates counter-clockwise displacing the locking pin 820 out of hole 814 in the direction of arrow D in FIG. 8D. After the locking pin 820 is displaced out of the hole 814 (i.e., is disengaged from arm 810), the arm 810 is free to pivot about axis E-E to fold downwardly into the retracted configuration. Where the arm 810 optionally includes the flange 840, when the arm 810 is folded into the retracted configuration, the locking hole 840a may be aligned with the pin 820. Then, when so aligned, the pin 820 can be inserted into the hole 840a by movement of the handle 824 opposite the direction of arrow C to lock the arm 810 in the retracted configuration.

When a user wishes to connect a car seat to seat 700″ (FIG. 8A), a user may unlock the arms 810 using the latches 822 as described above, and rotate the arms 810 into their upright deployed configuration and lock them. A user can then connect the car seat to the connectors 812 on the arms. When a user no longer wishes to use the car seat with the seat 700″, a user may disconnect the car seat from the connectors 812 of the arms 810 and unlock the arms using the latches 822 as described above and fold the arms 810 into their retracted configuration, where the arms 810 may be locked in position.

There have been described and illustrated herein several embodiments of a vehicle seat and frame with integrated car seat mounting arrangements. While particular embodiments of the invention have been described, it is not intended that the invention be limited thereto, as it is intended that the invention be as broad in scope as the art will allow and that the specification be read likewise. Thus, while mounting arrangements and patters have been shown and described for concealment when not in use for connection to a car seat, it will be appreciated that other mounting arrangements may be used depending on the corresponding connection arrangement of the car seat. It will therefore be appreciated by those skilled in the art that yet other modifications could be made to the provided invention without deviating from its spirit and scope as claimed.

What is claimed is:

1. A vehicle seat comprising:
a vehicle seat frame connected directly to a chassis of a vehicle, the seat frame including a back portion and a seat bottom portion, wherein the seat bottom portion includes at least one connector configured for removably connecting to a corresponding connector of a car seat; and
a cover covering the seat frame, the cover being configured in a first configuration to cover and conceal the at least one connector of the seat bottom portion and in a second configuration to expose the at least one connector of the seat bottom portion, wherein at least one portion of the cover is at least partially removable from the cover to expose the at least one connector of the seat bottom portion so that the at least one connector of the seat bottom portion can be used to connect to the corresponding connector of the car seat.

2. The vehicle seat of claim 1, wherein: the at least one portion of the cover is configured to be detached and reattached by hand.

3. The vehicle seat of claim 1, wherein: the cover includes a cushion material between an outer surface of the cover and the seat frame, and wherein the at least one portion of the cover is hingedly connected to the cover to fold out of the way of the at least one connector of the seat bottom portion in the first configuration.

4. The vehicle seat of claim 1, wherein: the at least one connector of the seat bottom portion is connected to an arm that is pivotally connected to the vehicle seat frame, wherein the arm is configured to pivot relative to the vehicle seat frame between an upright deployed configuration and a folded retracted configuration, and wherein in the deployed configuration the at least one connector of the seat bottom portion is positioned above the seat bottom portion and in the retracted configuration the at least one connector of the seat bottom portion is positioned flush or below the seat bottom portion.

5. The vehicle seat of claim 1, wherein: the at least one portion of the cover includes a selectively displaceable shutter which is configured to slide relative to the at least one connector of the seat bottom portion between a first position in which the shutter conceals the at least one connector of the seat bottom portion and a second position in which the shutter exposes the at least one connector of the seat bottom portion.

6. The vehicle seat of claim 1, wherein: the at least one portion of the cover includes vertically displaceable members which can be translated relative to an upper surface of the cover between an upper position in which the at least one portion of the cover conceals the at least one connector of the seat bottom portion and a lower position in which the at least one portion of the cover exposes the at least one connector of the seat bottom portion.

7. The vehicle seat of claim 6, wherein: the at least one portion of the cover is biased towards the upper position.

8. The vehicle seat of claim 7, wherein: the vertically displaceable members translate in a connection socket of the seat bottom portion between the upper position and the lower position, wherein the socket is configured to receive the corresponding connector of the car seat.

9. The vehicle seat of claim 8, wherein: the sockets are defined by a frustoconical inner surface and the corresponding connector of the car seat is defined by a frustoconical outer surface.

10. The vehicle seat of claim 8, further comprising: a resilient member between the at least one connector of the car seat and the socket, the resilient member configured to apply a separating force between the at least one connector of the car seat and the socket when the at least one connector of the car seat is connected to the socket.

11. The vehicle seat of claim 1, wherein: the back portion and the seat bottom portion of the vehicle seat frame are pivotally coupled to each other and are configured to be selectively locked at an angular position relative to one another.

12. The vehicle seat of claim 1, wherein: the seat bottom portion includes a release device configured to disconnect the car seat from the vehicle seat frame.

13. The vehicle seat of claim 2, wherein: the seat bottom portion includes a plurality of connectors arranged in a pattern and the car seat includes a plurality of connectors arranged in the same pattern, wherein the pattern is configured so that the car seat can only be oriented in a forward or rear facing orientation with respect to the vehicle seat when car seat is connected to the vehicle seat.

14. The vehicle seat of claim 13, wherein: the pattern is one of a rectangle and a diamond.

15. A car seat system comprising:
a vehicle seat according to claim 1; and
a car seat having at least one connector corresponding to the at least one connector of the vehicle seat.

16. A method of connecting a car seat to a vehicle seat comprising:
providing a vehicle seat according to claim 1;
providing a car seat having at least one connector corresponding to the at least one connector of the seat bottom portion;
configuring the cover into the second configuration to expose the at least one connector of the seat bottom portion;
positioning the car seat to vertically align the at least one connector of the car seat with the at least one connector of the seat bottom portion; and
connecting the at least one connector of the car seat with the aligned at least one connector of the seat bottom portion.

17. The method according to claim 16, wherein: configuring the cover into the second configuration includes moving a portion of the cover away from and out of alignment with the at least one connector of the seat bottom portion.

18. The method according to claim 16, wherein: wherein the at least one connector of the seat bottom portion includes a socket and wherein configuring the cover into the second configuration includes pushing a portion of the cover towards the socket by the at least one connector of the car seat.

19. The method according to claim 16, wherein connecting the at least one connector of the car seat with the aligned at least one connector of the seat bottom portion includes moving the car seat in a substantially vertical direction to connect the at least one connector of the car seat to the at least one connector of the seat bottom portion.

20. The method according to claim 16, wherein: the at least one connector of the seat bottom portion extends from an arm that is pivotally connected to the bottom seat portion and is configured to pivoted between an upright deployed configuration and a folded retracted configuration below the cover, and wherein the method further includes raising the arm into the deployed configuration prior to positioning the car seat in order to position the at least one connector of the seat bottom portion above the cover of the seat bottom portion.
